(19) United States
(12) Patent Application Publication
(10) Pub. No.: US 2023/0050999 A1
(43) Pub. Date: Feb. 16, 2023

(54) RAMAN SPECTROSCOPY METHOD AND RAMAN SPECTROSCOPY SUPPORT DEVICE

(71) Applicant: Panasonic Intellectual Property Management Co., Ltd., Osaka (JP)

(72) Inventors: Kiyoshi HASHIMOTODANI, Kyoto (JP); Yuki KUSHIDA, Kyoto (JP); Yusuke KITAGAWA, Hyogo (JP)

(21) Appl. No.: 17/794,171

(22) PCT Filed: Jan. 21, 2021
(86) PCT No.: PCT/JP2021/002019

§ 371 Date: Jul. 20, 2022

(30) Foreign Application Priority Data
Jan. 24, 2020 (JP) 2020-009642

(51) Int. Cl. G01J 3/44; G01J 3/02

(52) U.S. Cl. CPC G01J 3/4406; G01J 3/4412; G01J 3/0291; G01J 2003/4424

(57) ABSTRACT

A Raman spectroscopy method includes acquiring a first spectrum of a sample by performing exposure over a first time period in Raman spectroscopy of the sample, calculating a first Raman signal intensity of the first spectrum acquired, calculating a second time period from the first time period based on the ratio of the first Raman signal intensity calculated to a second Raman signal intensity that is a Raman signal intensity required for the Raman spectroscopy, the second time period being an exposure time period required for acquiring the second Raman signal intensity, and acquiring a second spectrum of the sample by performing exposure over the second time period calculated.

### CROSS-REFERENCE TO RELATED APPLICATIONS

This application is the U.S. National Phase under 35 U.S.C. § 371 of International Patent Application No. PCT/JP2021/002019, filed on Jan. 21, 2021, which in turn claims the benefit of Japanese Patent Application No. 2020-009642, filed on Jan. 24, 2020, the entire content of each of which is incorporated herein by reference.

### TECHNICAL FIELD

The present disclosure relates to a Raman spectroscopy method and a Raman spectroscopy support device that supports a device that executes the Raman spectroscopy method.

### BACKGROUND ART

Raman spectroscopy is a technology for measuring the concentration of a specific substance in a sample containing a plurality of substances. Raman spectroscopy utilizes a phenomenon in which light entering a substance is scattered by the substance (what is called Raman scattered light) and the scattered light has a wavelength different from the wavelength of the light having entered the substance because molecules and crystals each have specific vibrational energy according to the structure thereof, so that Raman spectroscopy excels in selectivity of the specific substance.

However, depending on the radiated light and the type of the sample, fluorescence emission accompanies the Raman emission in some cases. The fluorescence emission is emission of light having a wavelength longer than the wavelength of the radiated light. In measurement of Stokes Raman scattered light, in particular, which is measurement of the spectrum of the Raman light, which belongs to a wavelength band formed of wavelengths longer than the wavelength of the radiated light, the spectrum of the Stokes Raman scattered light overlaps with the spectrum of the fluorescence in some cases.

There is therefore a need for a simple method for removing the influence of the fluorescence from the spectrum measured by Raman spectroscopy. For example, Patent Literature 1 discloses a system and a method for extracting the chemical features of a drug by performing correction using convolution of a system response function on a spectrum acquired with a spectrometer, normalizing the intensity of the acquired spectrum to achieve normalized intensity on a predetermined scale, and removing the fluorescence baseline.

### CITATION LIST

### Patent Literature

[PTL 1] Japanese Unexamined Patent Application Publication (Translation of PCT Application) No. 2012-500994

### SUMMARY OF INVENTION

### Technical Problem

The technology of the related art described in Patent Literature 1, however, requires a long time period and many computational resources because the measurement needs to be repeated multiple times to determine the exposure time period that allows sufficient quantum counts to be provided after the removal of the fluorescence baseline.

In view of the circumstances described above, the present disclosure provides a Raman spectroscopy method that readily allows determination of an appropriate exposure time period in Raman spectroscopy and therefore allows quick, accurate Raman spectroscopy of a sample. The present disclosure further provides a Raman spectroscopy support device that readily allows determination of an appropriate exposure time period in Raman spectroscopy.

### Solution to Problem

In accordance with an aspect of the present disclosure, a Raman spectroscopy method includes: acquiring a first spectrum of a sample by performing exposure over a first time period in Raman spectroscopy of the sample; calculating a first Raman signal intensity of the first spectrum acquired; calculating a second time period from the first time period based on a ratio of the first Raman signal intensity calculated to a second Raman signal intensity that is a Raman signal intensity required for the Raman spectroscopy, the second time period being an exposure time period required for acquiring the second Raman signal intensity; and acquiring a second spectrum of the sample by performing exposure over the second time period calculated.

In accordance with another aspect of the present disclosure, a Raman spectroscopy support device includes: an acquirer that acquires a first spectrum obtained by Raman spectroscopy in which a sample is exposed over a first time period; a calculator that calculates a first Raman signal intensity of the first spectrum acquired, and a second time period from the first time period based on a ratio of the first Raman signal intensity calculated to a second Raman signal intensity that is a Raman signal intensity required for the Raman spectroscopy, the second time period being an exposure time period required for acquiring the second Raman signal intensity; and an outputter that outputs an instruction to perform exposure over the second time period calculated.

It should be noted that general or specific aspects of the present disclosure may be implemented to a system, a device, a method, an integrated circuit, a computer program, a non-transitory computer-readable recording medium such as a Compact Disc-Read Only Memory (CD-ROM), or any given combination thereof.

### Advantageous Effects of Invention

The present disclosure provides a Raman spectroscopy method and a Raman spectroscopy support device that readily allow determination of an appropriate exposure time period in Raman spectroscopy.

### BRIEF DESCRIPTION OF DRAWINGS

FIG. 1 is a block diagram showing an example of the configuration of a Raman spectroscopy system according to an embodiment.

FIG. 2 shows an example of the configuration of a Raman spectroscopy device according to a variation of the embodiment.

FIG. 3 is a flowchart showing an example of the procedure of a Raman spectroscopy method according to the embodiment.

FIG. 4 is a sequence diagram showing an example of the action of the Raman spectroscopy system as a whole in the embodiment.

FIG. 5 is a diagram showing examples of a spectrum in the Raman spectroscopy of oils used for different time periods.

FIG. 6 is a diagram showing examples of a Raman signal spectrum as a result of subtraction of a fluorescence baseline from the spectra in FIG. 5.

FIG. 7 shows the correlation between a fluorescence noise intensity and a Raman signal average intensity.

FIG. 8 is a diagram showing an example of the Raman signal spectrum produced when the exposure time period is short (exposure for a first time period, for example).

FIG. 9 is a diagram showing an example of the Raman signal spectrum produced when the exposure time period is sufficiently long.

FIG. 10 is a diagram showing an example of the Raman spectroscopy system including the Raman spectroscopy device according to the variation of the embodiment.

FIG. 11 is a flowchart showing an example of the action of a diagnosis device.

### DESCRIPTION OF EMBODIMENTS

(Findings that Lead to Present Disclosure)

In recent years, Raman spectroscopy has attracted attention as an approach to chemical analysis of substances. Raman spectroscopy is a technology for irradiating a substance to be measured with excitation light having a single wavelength, typically laser light, to produce a mixture of the reflected light (Rayleigh light) and light having a wavelength different from that of the excitation light (Raman scattered light) and producing information on the chemical properties of the substance under measurement from the spectrum of the Raman scattered light. Raman scattered light is, however, extremely weak light having an intensity of only about 10⁻⁶ the intensity of the Rayleigh light, which is the reflected or scattered light having the same wavelength as that of the excitation light. Therefore, a high-sensitivity detector and optical system are required, and the laser that serves as the excitation light source also needs to have high performance in terms of wavelength stability, monochromaticity, and other factors. For the reason described above, Raman spectroscopy, despite of the high utility thereof, has been less widely applied to the industries than infrared absorption spectroscopy.

Raman spectroscopy, in which the difference in wave number between the Raman scattered light and the excitation light (what is called Raman shift) corresponds to the difference in energy between the vibrational levels of the chemical bond of the molecules that form the substance under measurement, provides roughly the same information on the chemical bond as that provided by infrared absorption spectroscopy, which is typical vibrational spectroscopy. It should be noted here that in Raman scattered light, it is not the excitation light itself but is the wavelength shift from the excitation light (difference in inverse of energy in photon quantum theory) that corresponds to the chemical bond. That is, the wavelength of the excitation light is an arbitrary wavelength, and light having any wavelength, such as ultraviolet light, visible light, and near-infrared light, can be used as the excitation light. General-purpose optical elements for the visible light range can thus be used without the need for special detectors and optical elements, unlike in infrared absorption spectroscopy.

Furthermore, in Raman spectroscopy, in principle, a target to be measured (oil in the description) is irradiated with excitation light having a specific wavelength, typically visible laser light. Laser light has a very high energy density and may therefore induce autofluorescence in the target to be measured. That is, depending on the components contained in the target to be measured, an autofluorescence signal much higher than the Raman scattered light signal is generated in some cases, and the autofluorescence hinders the analysis of weak Raman scattered light. For example, to detect weak Raman scattered light, a longer exposure time is typically required for acquiring the spectrum of the weak Raman scattered light. When an autofluorescence signal much higher than the Raman scattered light signal is generated, however, the output from a photodetector for spectrum measurement (hereinafter referred to as spectrum measuring device) is likely to be saturated with the autofluorescence. That is, when most of the photons incident on the spectrum measuring device are those that form the fluorescence, the output from the spectrum measuring device will be saturated during the exposure. When the state of the spectrum measuring device reaches the state described above, subtracting the fluorescence baseline function from the resultant spectrum cannot produce a Raman signal spectrum. To eliminate the problem described above, exposure for a certain time period is performed multiple times to prevent the output from the spectrum measuring device from being saturated by the autofluorescence.

The method described above is, however, labor intensive because generation of a Raman signal spectrum with necessary accuracy requires performing measurement using exposure for a certain time period multiple times and averaging the number of photons received by the spectrum measuring device to calculate the final photon count.

The method described above further requires performing function fitting on fluorescence baseline and calculating a Raman signal spectrum by subtracting the fluorescence baseline function from the spectrum whenever the measurement is made, resulting in a large amount of spectrum-related operation.

Moreover, it is difficult for the method described above to predict an appropriate exposure time period that allows generation of a sufficiently accurate Raman signal spectrum.

In view of the challenges described above, the inventors of the present application have intensively conducted studies and found a method that readily allows prediction of an appropriate exposure time period for producing a sufficiently accurate Raman signal spectrum.

The present disclosure provides a Raman spectroscopy method that readily allows determination of an appropriate exposure time period in Raman spectroscopy and therefore allows quick, accurate Raman spectroscopy of a sample. The present disclosure further provides a Raman spectroscopy support device that readily allows determination of an appropriate exposure time period in Raman spectroscopy.

An overview of an aspect of the present disclosure is as follows.

In accordance with an aspect of the present disclosure, a Raman spectroscopy method includes: acquiring a first spectrum of a sample by performing exposure over a first time period in Raman spectroscopy of the sample; calculating a first Raman signal intensity of the first spectrum acquired; calculating a second time period from the first time period based on a ratio of the first Raman signal intensity calculated to a second Raman signal intensity that is a Raman signal intensity required for the Raman spectroscopy, the second time period being an exposure time period required for acquiring the second Raman signal intensity; and acquiring a second spectrum of the sample by performing exposure over the second time period calculated.

As described above, in the Raman spectroscopy method according to the aspect of the present disclosure, based on the ratio of the first Raman signal intensity calculated to the second Raman signal intensity, which is the Raman signal intensity required for the analysis, the exposure time period required for producing the second Raman signal intensity (that is, second time period) can be readily calculated from the first time period. Therefore, according to the method, a single test exposure allows the determination of an appropriate exposure time period for producing a sufficiently accurate Raman signal spectrum. Therefore, the amount of arithmetic processing can be reduced, and the analysis time period can be shortened, whereby the Raman spectroscopy of the sample can be performed quickly.

The Raman spectroscopy method according to the aspect of the present disclosure therefore readily allows determination of an appropriate exposure time period in the Raman spectroscopy and therefore allows quick, accurate Raman spectroscopy of the sample.

For example, it is possible that the calculating of the first Raman signal intensity includes: calculating a fluorescence intensity of fluorescence noise included in the first spectrum acquired; calculating the first Raman signal intensity that is a Raman signal intensity corresponding to the fluorescence intensity in the first spectrum, based on a correlation between a fluorescence intensity of fluorescence noise and a Raman signal intensity in a spectrum of the Raman spectroscopy, the correlation being calculated in advance.

The Raman spectroscopy method according to the aspect of the present disclosure, which calculates the first Raman signal intensity from the fluorescence intensity of the fluorescence noise contained in the first spectrum based on the correlation calculated in advance, therefore eliminates the need for complex arithmetic processing such as function fitting. The Raman spectroscopy method according to the aspect of the present disclosure can therefore readily and quickly calculate the first Raman signal intensity.

For example, it is possible that the calculating of the fluorescence intensity is performed by executing function fitting on a baseline that is fluorescence noise depending on a waveform of the first spectrum.

The Raman spectroscopy method according to the aspect of the present disclosure, which allows determination of an appropriate exposure time period even for a sample having an unknown fluorescence baseline shape, allows accurate determination of the exposure time period.

For example, it is possible that in the calculating of the fluorescence intensity, a maximum value of a baseline that is fluorescence noise depending on a waveform of the first spectrum is calculated as the fluorescence intensity.

The Raman spectroscopy method according to the aspect of the present disclosure therefore allows the fluorescence intensity of the fluorescence noise to be readily and quickly calculated by simply finding the maximum value of the fluorescence baseline of the Raman signal spectrum without no need for mathematical processing.

For example, it is possible that the correlation is calculated in advance and corresponds to a type of the sample, and the calculating of the first Raman signal intensity is performed based on the correlation corresponding to the type of the sample.

The Raman spectroscopy method according to the aspect of the present disclosure, which allows calculation of the first Raman signal intensity associated with the sample based on the correlation according to the type of the sample, therefore allows an appropriate exposure time period to be readily determined in accordance with the type of the sample.

In accordance with another aspect of the present disclosure, a Raman spectroscopy support device includes: an acquirer that acquires a first spectrum obtained by Raman spectroscopy in which a sample is exposed over a first time period; a calculator that calculates a first Raman signal intensity of the first spectrum acquired, and a second time period from the first time period based on a ratio of the first Raman signal intensity calculated to a second Raman signal intensity that is a Raman signal intensity required for the Raman spectroscopy, the second time period being an exposure time period required for acquiring the second Raman signal intensity; and an outputter that outputs an instruction to perform exposure over the second time period calculated.

As described above, based on the ratio of the first Raman signal intensity calculated to the second Raman signal intensity, which is the Raman signal intensity required for the analysis, the Raman spectroscopy support device according to the aspect of the present disclosure allows the exposure time period required for producing the second Raman signal intensity (that is, second time period) to be readily calculated from the first time period. Therefore, according to the device, single test exposure allows determination of an appropriate exposure time period for producing a sufficiently accurate Raman signal spectrum. As a result, the amount of arithmetic processing can be reduced, and the analysis time period can be shortened in the Raman spectroscopy.

The Raman spectroscopy support device according to the aspect of the present disclosure therefore allows an appropriate exposure time period to be readily determined in Raman spectroscopy.

It is possible that the Raman spectroscopy support device further includes: a storage that stores a correlation between a fluorescence intensity of fluorescence noise and a Raman signal intensity in a spectrum of the Raman spectroscopy, the correlation being calculated in advance, wherein the calculator calculates: a fluorescence intensity of fluorescence noise included in the first spectrum acquired by the acquirer; and the first Raman signal intensity that is a Raman signal intensity corresponding to the fluorescence intensity in the first spectrum based on the correlation stored in the storage.

The Raman spectroscopy support device according to the aspect of the present disclosure, which calculates the first Raman signal intensity from the fluorescence intensity of the fluorescence noise contained in the first spectrum based on the correlation calculated in advance, therefore eliminates the need for complex arithmetic processing such as function fitting. The Raman spectroscopy support device according to the aspect of the present disclosure can therefore readily and quickly calculate the first Raman signal intensity.

It should be noted that general or specific aspects of the present disclosure may be implemented to a system, a device, a method, an integrated circuit, a computer program, a non-transitory computer-readable recording medium such as a Compact Disc-Read Only Memory (CD-ROM), or any given combination thereof.

Hereinafter, certain exemplary embodiments will be described in detail with reference to the accompanying Drawings.

The following embodiments are general or specific examples of the present disclosure. The numerical values, shapes, materials, elements, arrangement and connection configuration of the elements, steps, the order of the steps, etc., described in the following embodiments are merely examples, and are not intended to limit the present disclosure. Among elements in the following embodiments, those not described in any one of the independent claims indicating the broadest concept of the present disclosure are described as optional elements.

It should be noted that the respective figures are schematic diagrams and are not necessarily precise illustrations. Additionally, components that are essentially the same share like reference signs in the figures. Accordingly, overlapping explanations thereof are omitted or simplified.

It should also be noted that the following description may include words expressing relationships between constituent elements, such as parallel or perpendicular, words expressing shapes of the constituent elements, such as square or rectangular, and ranges of numerical values. However, such expressions do not mean exact meanings only. They also mean the substantially same ranges including a difference of, for example, about several % from the completely same range.

### Embodiment

### [Raman Spectroscopy System]

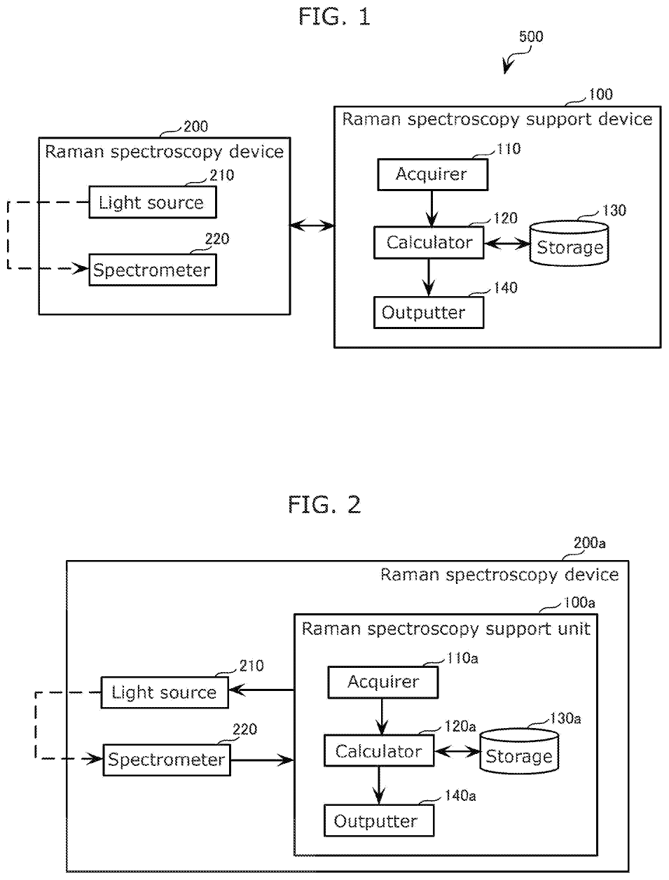

A Raman spectroscopy system according to an embodiment will first be described. FIG. 1 is a block diagram showing an example of the configuration of Raman spectroscopy system 500 according to the embodiment. In FIG. 1, the broken line shows the movement of light, and the solid lines show the direction of signal transmission. Raman spectroscopy system 500 is a system that readily determines an appropriate exposure time period for producing a Raman signal having intensity required for Raman spectroscopy to quickly analyze a sample.

Raman spectroscopy system 500 includes, for example, Raman spectroscopy device 200 and Raman spectroscopy support device 100, as illustrated in FIG. 1. Raman spectroscopy device 200 performs Raman spectroscopy on a sample. Raman spectroscopy support device 100 supports Raman spectroscopy device 200 in such a way that Raman spectroscopy device 200 can readily and accurately perform the Raman spectroscopy. Specifically, Raman spectroscopy support device 100 readily determines an appropriate exposure time period (hereinafter also referred to as second time period) that allows Raman spectroscopy device 200 to produce a sufficiently accurate Raman signal spectrum, and outputs an instruction of exposure over the second time period to Raman spectroscopy device 200.

The components of Raman spectroscopy system 500 will each be more specifically described below.

### [Raman Spectroscopy Device]

The configuration of Raman spectroscopy device 200 will first be described. Raman spectroscopy device 200 radiates excitation light to a sample and measures the spectrum of Raman scattered light contained in the scattered light emitted from the sample as a result of the radiation of the excitation light. More specifically, Raman spectroscopy device 200 first radiates the excitation light to the sample over a first time period (that is, exposes sample to excitation light for first time period), measures a first spectrum of the sample, and outputs the first spectrum to Raman spectroscopy support device 100. After acquiring from Raman spectroscopy support device 100 an instruction of exposure over the second exposure time period calculated from the first time period, Raman spectroscopy device 200 radiates the excitation light over the second time period to the sample (that is, exposes sample to excitation light for second time period), measures a second spectrum of the sample, and outputs the second spectrum. The term outputting may mean, for example, outputting data to a presentation unit (not shown) or to an external device, such as a user terminal and other communication terminals or a data analyzer.

Raman spectroscopy device 200 includes light source 210 and spectrometer 220, as shown in FIG. 1. Light source 210 radiates the excitation light to the sample. The excitation light may be ultraviolet light, visible light, or infrared light. Among the types of light described above, the excitation light is preferably visible light. An inexpensive visible laser can thus be used as light source 210. In addition, an inexpensive optical system for visible light can be used. Raman spectroscopy device 200 can thus be manufactured at a lower cost, whereby the versatility of Raman spectroscopy system 500 is improved.

Spectrometer 220 derives the spectrum of the Raman scattered light (hereinafter also referred to as Raman signal spectrum) by spectroscopically separating the Raman scattered light emitted from the sample as a result of the radiation of the excitation light. For example, spectrometer 220 includes a measurement unit (not shown) that measures the spectrum of the Raman scattered light emitted from the sample as a result of the radiation of the excitation light, and an outputter (not shown) that outputs the measured Raman signal spectrum to Raman spectroscopy support device 100. Spectrometer 220 may further include a filter (not shown) and a spectral separator (not shown). The light reflected off and scattered by the sample as a result of the radiation of the excitation light is incident on spectrometer 220. The reflected light is light having the same wavelength as that of the excitation light and is what is called Rayleigh light. The light incident on spectrometer 220 enters the filter. The filter is, for example, a band-stop filter that transmits the scattered light and removes the Rayleigh light. The scattered light having passed through the filter is spectrally separated by the spectral separator into light on a wavelength band basis. The intensity of the light having been spectrally separated on a wavelength band basis by the spectral separator is measured by the measurement unit. The measurement unit includes, for example, an imaging element (not shown) that receives the light having been spectrally separated on a wavelength band basis by the spectral separator and converts the light into an electric signal. The imaging element outputs the converted electric signal in the form of a digital value to the outputter. The outputter outputs the digital value representing the intensity of the light on a wavelength band basis to Raman spectroscopy support device 100 as the spectrum of the Raman scattered light from the sample. The configuration of spectrometer 220 described above is presented by way of example; spectrometer 220 only needs to be capable of measuring the Raman signal spectrum by spectrally separating the Raman scattered light from the sample, and the configuration of spectrometer 220 and how spectrometer 220 measures the Raman signal spectrum are not limited to specific ones.

### [Raman Spectroscopy Support Device]

The configuration of Raman spectroscopy support device 100 will be subsequently described. Raman spectroscopy support device 100 readily determines an appropriate exposure time period (hereinafter also referred to as second time period) that allows Raman spectroscopy device 200 to produce a sufficiently accurate Raman signal spectrum, and outputs an instruction of exposure over the second time period to Raman spectroscopy device 200.

Raman spectroscopy support device 100 includes, for example, acquirer 110, calculator 120, storage 130, and outputter 140, as shown in FIG. 1. Raman spectroscopy support device 100 is connected to Raman spectroscopy device 200. For example, Raman spectroscopy support device 100 may be connected to Raman spectroscopy device 200 via wireless communication, such as Bluetooth (registered trademark), or wired communication, such as Ethernet (registered trademark).

Acquirer 110 acquires the Raman signal spectrum associated with the sample and outputted from spectrometer 220. More specifically, acquirer 110 acquires the first spectrum produced by Raman spectroscopy device 200 through the Raman spectroscopy using the exposure to the sample over the first time period.

Calculator 120 calculates a first Raman signal intensity of the first spectrum acquired by acquirer 110. For example, calculator 120 calculates the fluorescence intensity of fluorescence noise contained in the first spectrum acquired by acquirer 110, calculates the first Raman signal intensity, which is the Raman signal intensity corresponding to the fluorescence intensity of the first spectrum, based on a correlation stored in storage 130, and calculates the second time period, which is an exposure time period required for producing a second Raman signal intensity, which is the Raman signal intensity required for the analysis, from the first time period based on the ratio of the first Raman signal intensity calculated to the second Raman signal intensity.

Storage 130 stores a pre-calculated correlation between the fluorescence intensity of the fluorescence noise and the Raman signal intensity in a spectrum in the Raman spectroscopy. For example, the correlation may be calculated in advance on a sample type basis and stored in storage 130. The correlation may, for example, be a function, or a table that relates inputs to outputs, such as a lookup table. In this case, the input is the fluorescence intensity of the fluorescence noise in a spectrum (first spectrum in the description) in the Raman spectroscopy, and the output is the Raman signal intensity (that is, first Raman signal intensity) in the spectrum (that is, first spectrum) in the Raman spectroscopy.

The correlation described above and a method for deriving the correlation will be described later in the section on a Raman spectroscopy method.

Outputter 140 outputs an instruction of exposure over the second time period calculated by calculator 120 to Raman spectroscopy device 200.

FIG. 1 shows the case where Raman spectroscopy support device 100 is incorporated in a device separate from Raman spectroscopy device 200, for example, a computer, and Raman spectroscopy support device 100 may instead be incorporated along with light source 210 and spectrometer 220 in a single device (see FIG. 2). FIG. 2 is a diagram showing an example of the configuration of Raman spectroscopy device 200a according to a variation of the embodiment.

Raman spectroscopy device 200a includes light source 210, spectrometer 220, and Raman spectroscopy support unit 100a, as shown in FIG. 2. Raman spectroscopy support unit 100a, acquirer 110a, calculator 120a, storage 130a, and outputter 140a functionally correspond to Raman spectroscopy support device 100, acquirer 110, calculator 120, storage 130, and outputter 140 shown in FIG. 1, respectively. Raman spectroscopy device 200a includes Raman spectroscopy support unit 100a, and light source 210 and spectrometer 220 are connected to Raman spectroscopy support unit 100a via wired communication, and thus Raman spectroscopy device 200a does not need to have a communication path via wireless communication. Raman spectroscopy device 200a may use as appropriate communication selected from the following candidates from the viewpoint of data transmission distance, the amount of transmitted data, and power consumption: cellular communications such as 4G, 5G, and LTE (long-term evolution), or GSM (global system for mobile communications) (registered trademark); short distance wireless communication such as Wi-Fi (wireless fidelity), Bluetooth (registered trademark), BLE (Bluetooth (registered trademark) low energy), Zigbee (registered trademark), and NFC (near field communication); LPWA (low power wide area) such as SIGFOX, LoRAWAN, and NB-Iot (narrow band Internet of things); and wide-area wireless communication such as eMTC (enhanced machine type communication) and iBURST. Therefore, for example, even when Raman spectroscopy system 500 is used with a construction machine, a vehicle, or any other machine having a limited communication path to a server, Raman spectroscopy system 500 is unlikely to interfere with the communication performed by the machine.

### [Raman Spectroscopy Method]

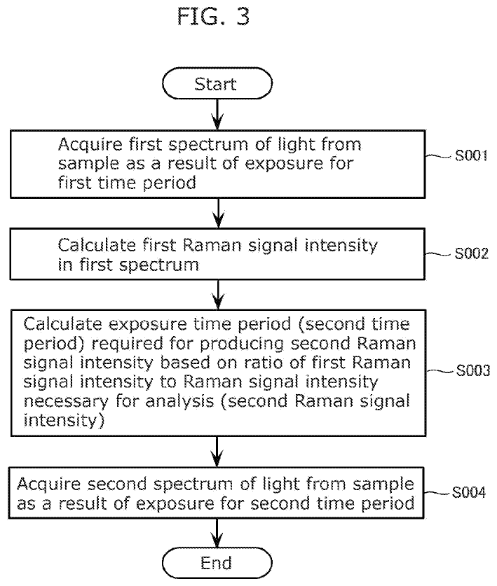

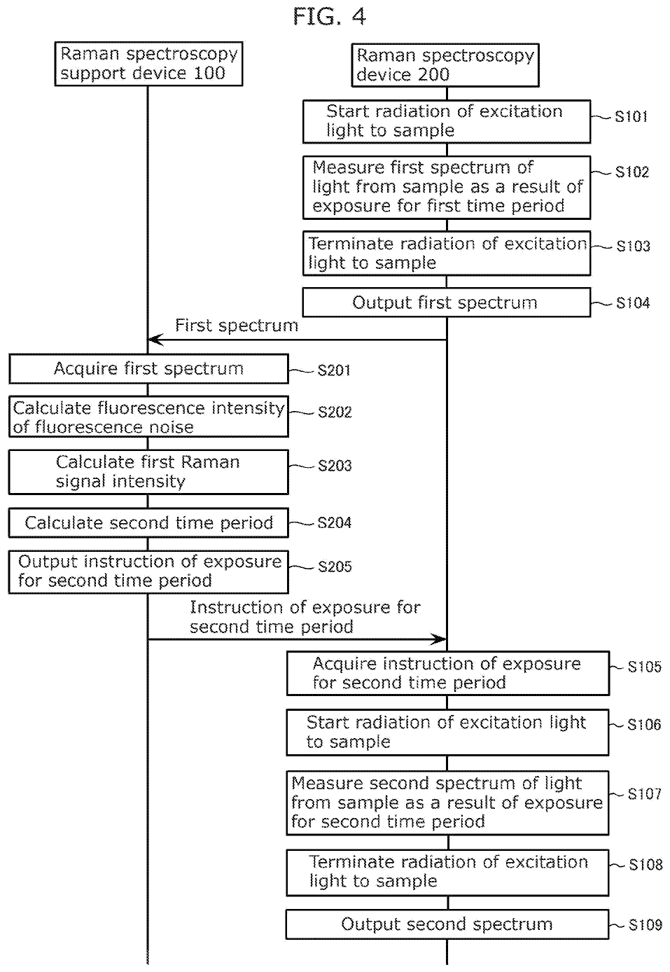

An example of the Raman spectroscopy method will be subsequently described with reference to FIGS. 3 and 4. FIG. 3 is a flowchart showing an example of the procedure of the Raman spectroscopy method according to the embodiment. FIG. 4 is a sequence diagram showing an example of the action of Raman spectroscopy system 500 as a whole in the embodiment.

In step S001, the first spectrum of the sample is acquired by the exposure over the first time period, as shown in FIG. 3. The term acquisition includes not only acquisition but also measurement. That is, step S001 in FIG. 3 may correspond to step S201 executed by Raman spectroscopy support device 100 shown in FIG. 4, or may correspond to a step including steps S101 to S104 executed by Raman spectroscopy device 200 and step S201 executed by Raman spectroscopy support device 100. The latter case will be described below with reference again to FIG. 1.

Light source 210 of Raman spectroscopy device 200 starts radiating the excitation light to the sample (step S101), as shown in FIG. 4. Simultaneously with or after the start of step S101, spectrometer 220 measures the spectrum of the Raman scattered light (referred to as first spectrum) emitted from the sample as a result of the exposure over the first time period (step S102). More specifically, in step S102, after or simultaneously with the timing when light source 210 starts radiating the excitation light to the sample in step S101, spectrometer 220 starts receiving (referred to as exposure) via the imaging element (not shown) the Raman scattered light that belongs to wavelength bands spectrally separated by the spectral separator (not shown). Spectrometer 220 then performs the exposure over the first time period and measures the first spectrum. Simultaneously with or after the completion of the exposure over the first time period in step S102, light source 210 stops radiating the excitation light to the sample (step S103).

The relationship between the time period for which the excitation light is radiated and the exposure time period for which the imaging element is exposed to light may be adjusted as appropriate in accordance with the sample to be measured and the aspect thereof. For example, when the sample is oil, and the excitation light is radiated to the oil in a stationary state thereof (state in which oil does not move along channel, for example), background fluorescence gradually decreases because the excitation light is continuously radiated to the oil that remains in the position where the oil is irradiated with the excitation light. Therefore, in this case, the exposure to the imaging element may be initiated after the sample is irradiated with the excitation light until the background fluorescence from the sample sufficiently decreases. That is, the time period for which the excitation light is radiated may be longer than the exposure time period for which the imaging element is exposed to the light. For example, when the excitation light is radiated to the oil circulating through a channel, the oil at the position where the excitation light is radiated to the oil constantly changes. That is, the background fluorescence is unlikely to change because the excitation light is not continuously radiated to a given oil. Therefore, in this case, the exposure to the imaging element may be initiated simultaneously with the radiation of the excitation light to the sample, and may be terminated simultaneously with the end of the radiation of the excitation light to the sample. That is, the time period for which the excitation light is radiated may be equal to the exposure time period for which the imaging element is exposed to the light.

The process in step S101 may be initiated, for example, when Raman spectroscopy device 200 acquires a measurement start instruction that a user inputs to an inputter (not shown), or may be initiated based on a preset schedule. The schedule may be stored, for example, in storage 130 of Raman spectroscopy support device 100.

Raman spectroscopy device 200 subsequently outputs the measured first spectrum to Raman spectroscopy support device 100 (step S104). Acquirer 110 of Raman spectroscopy support device 100 acquires the first spectrum outputted from Raman spectroscopy device 200 (step S201).

Subsequently, in step S002 in FIG. 3, the first Raman signal intensity of the first spectrum acquired in step S001 is calculated. Step S002 corresponds to step S203 in FIG. 4. Step S002 may correspond to a step including steps S202 and S203 in FIG. 4. In this case, in step S002 in FIG. 3, calculator 120 of Raman spectroscopy support device 100 calculates the fluorescence intensity of the fluorescence noise contained in the first spectrum acquired in step S201 in FIG. 4, for example, as in step S202 in FIG. 4. For example, calculator 120 may calculate the fluorescence intensity by performing function fitting on a baseline that is wave-number-dependent fluorescence noise in the first spectrum. An appropriate exposure time period can thus be determined even for a sample having an unknown fluorescence baseline shape, whereby the exposure time period can be accurately determined. For example, calculator 120 may calculate a maximum value of the baseline, which is the wave-number-dependent fluorescence noise in the first spectrum, as the fluorescence intensity. The fluorescence intensity of the fluorescence noise can thus be readily and quickly calculated by simply finding a maximum value of the fluorescence baseline of the Raman signal spectrum without no need for mathematical processing. The fluorescence intensity of the fluorescence baseline does not need to be the maximum value and may, for example, be the fluorescence intensity at a given wavenumber, or the average of the fluorescence baseline intensities.

Subsequently, in step S003 in FIG. 3, calculator 120 calculates the first Raman signal intensity, which is the Raman signal intensity corresponding to the fluorescence intensity of the first spectrum, based on the pre-calculated correlation between the fluorescence intensity of the fluorescence noise and the Raman signal intensity in the spectrum in the Raman spectroscopy, for example, as in step S203 in FIG. 4. For example, in step S203 in FIG. 4, calculator 120 reads the aforementioned correlation stored in storage 130 and calculates the first Raman signal intensity by substituting the fluorescence intensity of the fluorescence noise in the first spectrum into the correlation. The Raman signal intensity of the first spectrum (what is called first Raman signal intensity) can thus be readily and quickly calculated without complex arithmetic operation such as function fitting. For example, the correlation described above has been calculated in advance in correspondence with the type of the sample, and calculator 120 may instead calculate in step 203 the first Raman signal intensity based on the correlation described above according to the type of the sample. The first Raman signal intensity of the light from the sample can thus be calculated based on the correlation according to the type of the sample, whereby an appropriate exposure time period can be readily determined in accordance with the type of the sample.

As in the description of the configuration of the Raman spectroscopy support device, the correlation between the fluorescence intensity of the fluorescence noise and the Raman signal intensity in the spectrum in the Raman spectroscopy is calculated in advance in correspondence with the type of the sample and stored in storage 130. The correlation may be calculated in the form of a database in advance.

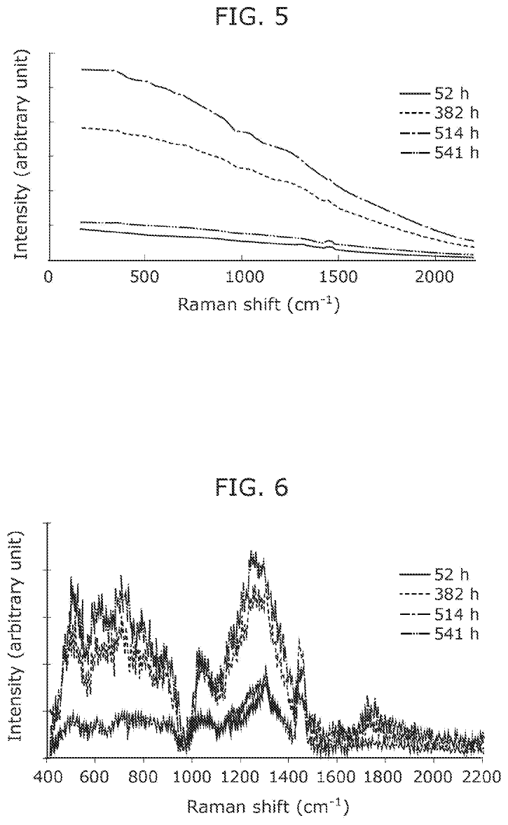

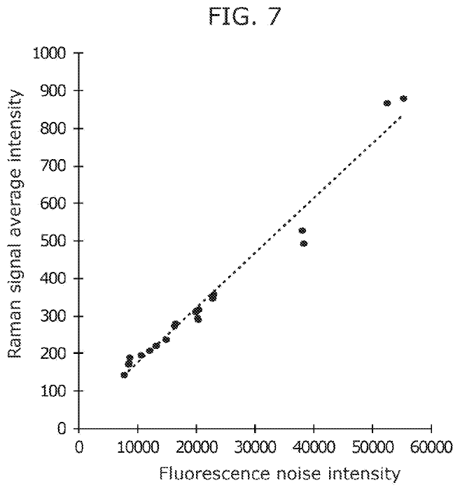

The correlation will now be described with reference to the drawings. The sample is, for example, oil. FIG. 5 is a diagram showing examples of the spectrum in the Raman spectroscopy of oils used for different time periods. FIG. 6 is a diagram showing examples of the Raman signal spectrum as a result of the subtraction of the fluorescence baseline from the spectra in FIG. 5. FIG. 7 shows the correlation between the fluorescence noise intensity and the Raman signal average intensity. FIGS. 5 and 6 show spectra of part (four) of the measured samples from the viewpoint of clarity of the figures, and FIG. 7 shows the correlation between the fluorescence noise intensity and the Raman signal average intensity of all the measured samples.

The spectra of the light from the oils used for different time periods indicate that the fluorescence intensity of the autofluorescence from the oils increases as the time period for which the oils are used increases, and that the fluorescence intensity of the autofluorescence from the oils decreases as the time period for which the oils are used exceeds a predetermined time period (514 hours in the example) and increases afterward, as shown in FIG. 5. The phenomenon described above may manifest itself due, for example, to substances (soot or colored substances, for example,) produced in association with the use of the oils. For example, soot or colored substances absorb the excitation light radiated to the sample and the Raman scattered light emitted from the sample, so that part of the excitation light and the Raman scattered light is lost.

As in the spectra in FIG. 5, when the time period for which the oils are used exceeds the predetermined time period (514 hours), the Raman signal spectra of the light from the oils also show decreases in the signal intensity of the Raman signal spectra of the oils as the time period for which the oils are used increases, as shown in FIG. 6.

The above interpretation indicates that the fluorescence intensity of the fluorescence noise from the oils is proportional to the signal intensity of the Raman signal spectrum.

In FIG. 7, the horizontal axis represents the maximum value of the fluorescence baseline in FIG. 5 (leftmost end of each spectrum in FIG. 5) as the fluorescence noise intensity, and the vertical axis represents the average intensity of the Raman signal spectrum in FIG. 6. The fluorescence noise intensity is linearly correlated with the Raman signal average intensity, as indicated by the broken line in FIG. 7.

Therefore, in the Raman spectroscopy method according to the present embodiment, the correlation between the fluorescence intensity of the fluorescence noise from the sample and the Raman signal intensity is calculated in advance in accordance with the type of the sample and can be used to readily determine an appropriate exposure time period in accordance with the type of the sample.

Subsequently, in step S004 in FIG. 3, the second time period, which is the exposure time period required for producing the second Raman signal intensity, is calculated from the first time period based on the ratio of the first Raman signal intensity calculated in step S003 to the second Raman signal intensity, which is the Raman signal intensity required for the analysis. Step S004 corresponds to step S204 in FIG. 4. For example, in the step, calculator 120 calculates the second time period by substituting the first Raman signal intensity calculated in step S003 into Equation 1 below.

$$[ Math . 1 ]$$

$${t}_{2} = {t}_{1} ( \frac{N}{n} ) \qquad ( Equation 1 )$$

In Equation 1 described above, t₁ represents the first time period, t₂ represents the second time period, n represents the first Raman signal intensity, and N represents the second Raman signal intensity.

Equation 1 described above will now be more specifically described with reference to FIGS. 7 and 6.

The symbol n in Equation 1 described above corresponds to the Raman signal average intensity in the correlation in FIG. 7. The Raman signal average intensity is the result of division of the sum of the Raman signal intensity values at wavelength points (that is, data points) in the Raman signal spectrum divided by the number of wavelength points (data points). The magnitude of the variation in the Raman signal intensity (that is, random noise) at the data points is √n because the magnitude is given based on a relative error according to the Poisson distribution. The average random noise level in the spectrum is therefore approximately 1/√n. Let N be the Raman signal average intensity that achieves the upper limit of a predetermined average random noise level, and the upper limit of the predetermined average random noise level is approximately 1/√N. The above discussion shows that the noise width decreases as the Raman signal intensity increases.

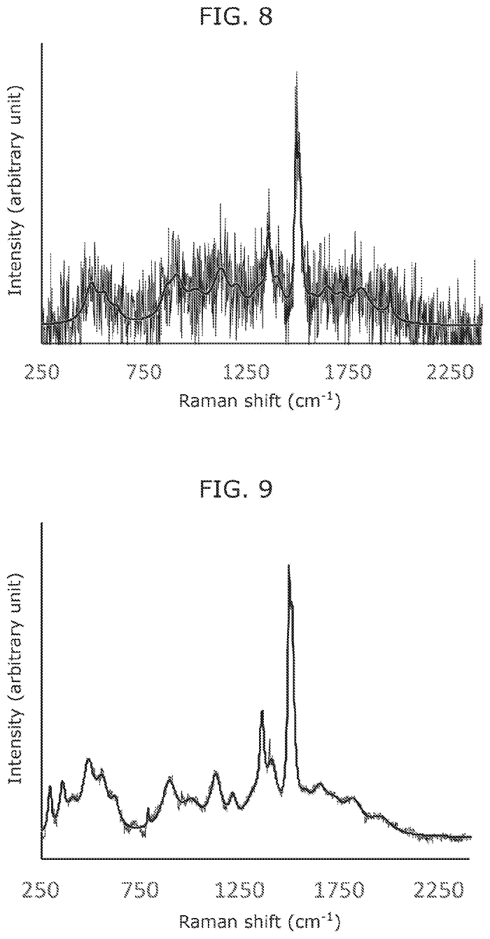

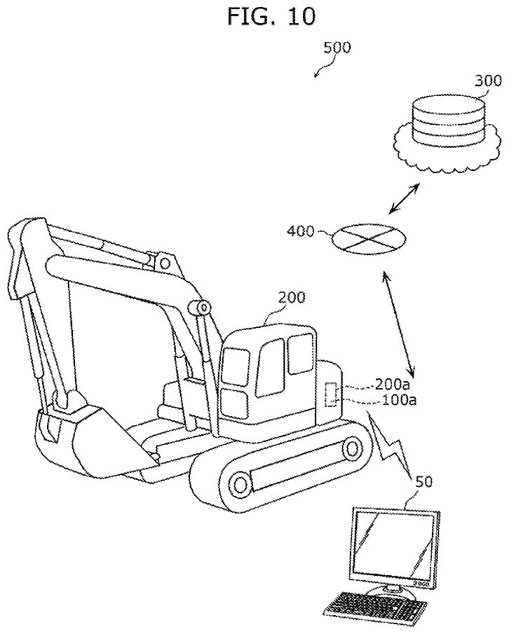

FIG. 8 is a diagram showing an example of the Raman signal spectrum produced when the exposure time period is short (exposure in the first time period, for example). FIG. 9 is a diagram showing an example of the Raman signal spectrum produced when the exposure time period is sufficiently long.

When the exposure time period is short, the variation in the Raman signal intensity at the data points is large, as shown in FIG. 8. On the other hand, when the exposure time period is long enough, for example, to achieve the upper limit of the predetermined average random noise, the variation in the Raman signal intensity at the data points is small, as shown in FIG. 9. The Raman signal intensity is proportional to the number of photons incident on the Raman measuring device, so that the exposure time is proportional to the number of photons.

Therefore, the Raman signal intensity n of the first spectrum produced by the exposure over first time period t₁ and the Raman signal intensity N of the second spectrum produced by the exposure over second time period t₂ are proportional to each other, as indicated by Equation 2 below.

$$[ Math . 2 ]$$

$$\frac{n}{{t}_{1}} = \frac{N}{{t}_{2}} \qquad ( Equation 2 )$$

Second time period t₂ is therefore calculated from the ratio shown by Equation 2 described above.

Subsequently, in step S005 in FIG. 3, the second spectrum of the sample is acquired as a result of the exposure over the second time period calculated in step S004. The term acquisition includes not only acquisition but also measurement, as described in step S001. Step S005 in FIG. 3 may therefore, for example, be a step including step S205 executed by Raman spectroscopy support device 100 shown in FIG. 4 and steps S105 to S109 executed by Raman spectroscopy device 200.

Outputter 140 of Raman spectroscopy support device 100 outputs a command of execution of the exposure over the second time period calculated by calculator 120 (that is, instruction of exposure for second time period) to Raman spectroscopy device 200 (step S205), as shown in FIG. 4. Raman spectroscopy device 200 subsequently acquires the instruction of the exposure over the second time period outputted from Raman spectroscopy support device 100 (step S105). Light source 210 starts radiating the excitation light to the sample in accordance with the instruction acquired in step S105 (step S106). Simultaneously with or after the start of step S106, spectrometer 220 measures the spectrum of the Raman scattered light (called second spectrum) emitted from the sample as a result of the exposure over the second time period in accordance with the instruction acquired in step S105 (step S107). In step S107, after or simultaneously with the timing when light source 210 starts radiating the excitation light to the sample in step S106, spectrometer 220 starts receiving the Raman scattered light, which belongs to the wavelength bands spectrally separated by the spectral separator (not shown), with the imaging element (not shown) (called exposure), as in step S102. Spectrometer 220 then performs the exposure over the second time period and measures the second spectrum. Simultaneously with or after the completion of the exposure over the second time period in step S107, light source 210 stops radiating the excitation light to the sample (step S108).

The relationship between the time period for which the excitation light is radiated and the exposure time period for which the imaging element is exposed to the light may be adjusted as appropriate in accordance with the sample to be measured and the aspect thereof, as described in step S102.

Raman spectroscopy device 200 subsequently outputs the second spectrum (step S109). For example, Raman spectroscopy device 200 may present the second spectrum by outputting the second spectrum to the presentation unit (not shown in FIG. 1) such as a monitor, user terminal 50 such as a computer or a tablet terminal (see FIG. 10), or diagnosis device 300 incorporated in a server (see FIG. 10).

### (Variation)

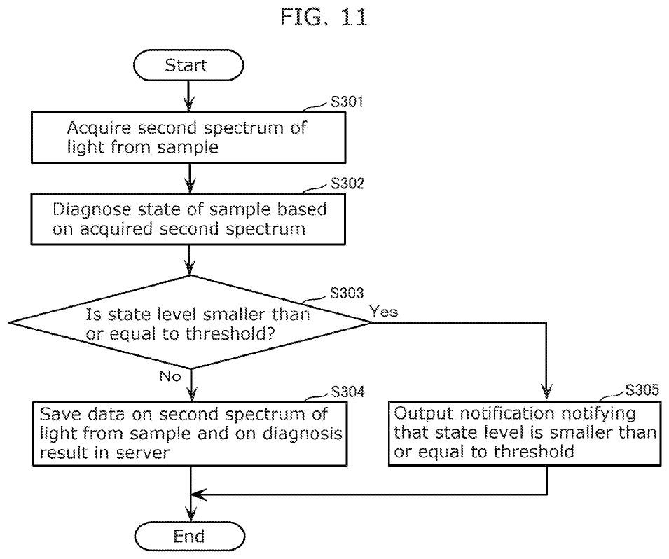

The Raman spectroscopy system according to a variation of the present embodiment will subsequently be described with reference to FIGS. 10 and 11. In the embodiment, Raman spectroscopy system 500 has been described with reference to a system that readily determines an appropriate exposure time period that allows generation of a Raman signal having an intensity required for the Raman spectroscopy and quickly analyzes the sample, and the present variation will be described with reference to a case where the analysis result is further analyzed and the result of the further analysis is fed back to the user.

FIG. 10 is a diagram showing an example of Raman spectroscopy system 500a including Raman spectroscopy device 200a (see FIG. 2) according to the variation of the embodiment. FIG. 11 is a flowchart showing an example of the action of diagnosis device 300.

Raman spectroscopy system 500a includes, for example, Raman spectroscopy device 200a, user terminal 50, and diagnosis device 300, as shown in FIG. 10.

Raman spectroscopy device 200a includes light source 210, spectrometer 220, and Raman spectroscopy support unit 100a, as shown in FIG. 2. For example, Raman spectroscopy device 200a is incorporated as an in-line device in mechanical device 10 such as a construction machine.

User terminal 50 is, for example, a computer and is so connected to Raman spectroscopy device 200a that the computer and Raman spectroscopy device 200a can communicate with each other. User terminal 50 is not limited to a computer and may be a smartphone, a mobile phone, a tablet terminal, a wearable terminal, a computer incorporated in mechanical device 10, or any other terminal.

Raman spectroscopy device 200a and user terminal 50 are connected to diagnosis device 300 in the server, for example, via network 400.

Mechanical device 10 includes, for example, a variety of large or small machines installed inside or outside factories, offices, public facilities, and residences, construction machines operating outdoors, a variety of vehicles such as trucks, buses, passenger cars, motorcycles, ships, airplanes, trains, industrial vehicles, and construction vehicles, or instruments such as engines, transmissions, and operating devices incorporated in the variety of machines described above.

A sample to be analyzed (what is called sample) or a target to be analyzed in the Raman spectroscopy may, for example, be consumables that are repeatedly used and periodically replaced in mechanical device 10. The consumables are, for example, oil that serves as a lubricating medium, a cooling medium, or a power transmission medium used in mechanical device 10, or members such as filters that filter the oil. Since the consumables are disposed in mechanical device 10, it is not easy for the user of mechanical device 10 to check the conditions of the consumables. Incorporating Raman spectroscopy device 200a in mechanical device 10 therefore allows inline-measurement of the conditions of the consumables disposed in mechanical device 10.

For example, the user may input operation information via the inputter (not shown) such as a touch panel, a keyboard, a mouse, or a microphone, and the inputter may transmit the information to Raman spectroscopy device 200a or diagnosis device 300. The user may select necessary information via the inputter and cause the presentation unit, such as a monitor or a loudspeaker, to present the information. The user can thus obtain information, for example, on the conditions of the consumables, timings when the consumables should be replaced, and troubles that may occur in mechanical device 10. The inputter and the presentation unit only need be connected to Raman spectroscopy support unit 100a, and may be provided in a device (user terminal 50, for example) different from the device in which Raman spectroscopy support unit 100a is incorporated (Raman spectroscopy device 200a in the description). The inputter and the presentation unit are each not necessarily a single unit, and a plurality of inputters and presentation units may be connectable to Raman spectroscopy support unit 100a. Raman spectroscopy device 200a, in which Raman spectroscopy support unit 100a is incorporated, may be connected to a server via network 400, transmit the second spectrum of each of the consumables to diagnosis device 300 in the server, and acquire diagnostic results as a result of the diagnosis performed by an information processing program stored in a database provided in diagnosis device 300. Raman spectroscopy support unit 100a may inform the user of the acquired diagnostic results by causing the presentation unit to present the results. Raman spectroscopy support unit 100a may control a controller that controls the functions of mechanical device 10, such as an ECU (electronic control unit), based on the acquired diagnostic results, and cause mechanical device 10 to perform a necessary action. For example, Raman spectroscopy support unit 100a outputs an instruction to control the function of the engine, a hydraulic instrument, or any other instrument of mechanical device 10 in accordance with the acquired diagnostic results to the controller. For example, when Raman spectroscopy support unit 100a determines based on the diagnosis results that the engine needs to be stopped, Raman spectroscopy support unit 100a outputs an instruction that instructs the controller of mechanical device 10 to stop the engine. Raman spectroscopy support unit 100a may further output an instruction that instructs the presentation unit to present the need to stop the engine. The presentation may, for example, be turning on a lamp or issuing a sound, or may be performed in the form of voice or text. The safety of the user who is operating mechanical device 10 is thus more readily ensured.

The action of Raman spectroscopy system 500a will be described below more specifically with reference to FIG. 11. It is assumed that Raman spectroscopy device 200a is installed in an oil channel in mechanical device 10 and performs inline-measurement of the condition of the oil.

As for the action of Raman spectroscopy device 200a, the actions of light source 210 and spectrometer 220 correspond to the action of Raman spectroscopy device 200 shown in FIG. 4, and the action of Raman spectroscopy support unit 100a corresponds to the action of Raman spectroscopy support device 100 shown in FIG. 4. The actions up to step S107 shown in FIG. 4 will therefore not be described.

Diagnosis device 300 acquires the second spectrum outputted by Raman spectroscopy device 200a (step S301), as shown in FIG. 11. Diagnosis device 300 then diagnoses the state of the sample based on the acquired second spectrum (step S302). At this point, diagnosis device 300 evaluates whether or not the level of the state of the sample (oil in the description) is smaller than or equal to a threshold (step S303). For example, diagnosis device 300 inputs the second spectrum of the sample to the database. The information processing program stored in the database outputs a result of the diagnosis of the state of the sample based on the peak intensity (Raman signal intensity) at a predetermined wave number in the second spectrum, or the overall or local shape features of the second spectrum. Thus, configured diagnosis device 300 may be realized, for example, by using a model provided by machine learning.

When the level of the state of the sample is smaller than or equal to the threshold (Yes in step S303), diagnosis device 300 outputs notification, as the diagnosis result, notifying user terminal 50 and Raman spectroscopy device 200a that the level of the state of the sample is smaller than or equal to the threshold, that is, the sample is not in good condition (step S305). In this case, diagnosis device 300 may further notify Raman spectroscopy device 200a of a problem that may arise due to the state of the sample, and measures taken to avoid the problem, and other pieces of information. Diagnosis device 300 may further output an instruction of control of the action of mechanical device 10 to avoid the problem.

On the other hand, when the level of the state of the sample is greater than the threshold (No in step S303), diagnosis device 300 saves data on the second spectrum of the sample and the results of the diagnosis of the level of the state of the sample and other factors in the server (step S304). The data may be saved in the database provided in diagnosis device 300, and desired data may be outputted to user terminal 50 in accordance with a request from the user.

As described above, Raman spectroscopy system 500a according to the present variation can cause diagnosis device 300 to diagnose the second spectrum associated with the sample and produced by Raman spectroscopy device 200a, and feed the state of the sample back to the user. The user can thus not only grasp the state of the sample in a timely manner, but also predict when the sample should be replaced. For example, when the sample is consumables disposed, for example, in a mechanical device, the user can grasp at an appropriate timing an appropriate point of time when the consumables should be replaced and a problem that may arise in the mechanical device.

The Raman spectroscopy method according to the present disclosure therefore readily allows determination of an appropriate exposure time period in Raman spectroscopy and therefore allows quick, accurate Raman spectroscopy of a sample. The Raman spectroscopy support device according to the present disclosure readily allows determination of an appropriate exposure time period in Raman spectroscopy. The present disclosure is therefore applicable not only to analytical applications but also to industrial applications, such as the present variation, and can be used to perform Raman spectroscopy of samples readily and quickly in a variety of fields, for example, cosmetics, medicine, and food.

### (Other Variations)

Although the Raman spectroscopy support device and the Raman spectroscopy method according to one or more aspects of the present disclosure have been described based on the embodiment, the present disclosure is not limited to this embodiment. Those skilled in the art will readily appreciate that embodiments arrived at by making various modifications to the above embodiment or embodiments arrived at by selectively combining elements disclosed in the above embodiment without materially departing from the scope of the present disclosure may be included within one or more aspects of the present disclosure.

For example, a part or all of the constituent elements included in the Raman spectroscopy support device may be realized via a single system large scale integrated (LSI) circuit. For example, the Raman spectroscopy support device may be a system LSI including a storage, an acquirer, a calculator, and an outputter. The system LSI may not include a light source.

A system LSI circuit is a multifunctional LSI circuit manufactured by integrating a plurality of units on a single chip, and is specifically a computer system including, for example, a microprocessor, ROM (Read Only Memory), and RAM (Random Access Memory). A computer program is stored in the ROM. The system LSI circuit achieves its function as a result of the microprocessor operating according to the computer program.

It should be noted that here, the terminology “system LSI circuit” is used, but depending on the degree of integration, the circuit may also refer to as IC, LSI circuit, super LSI circuit, or ultra LSI circuit. Moreover, the method of circuit integration is not limited to LSI. Integration may be realized with a specialized circuit or a general purpose processor. After the LSI circuit is manufactured, a field programmable gate array (FPGA) or a reconfigurable processor capable of reconfiguring the connections and settings of the circuit cells in the LSI circuit may be used.

Further, if an integrated circuit technology that replaces LSI emerges from advances in or derivations of semiconductor technology, integration of functional blocks using such technology may also be used. Application of biotechnology is also a possibility.

Furthermore, the aspect of the present disclosure may be not only the above-described Raman spectroscopy support device but also a Raman spectroscopy method including characteristic steps performed by the constituent elements included in the device. Moreover, an aspect of the present disclosure may be a computer program for causing a computer to execute the characteristic steps included in the Raman spectroscopy method. It may be a non-transitory computer-readable recording medium storing such a computer program.

### INDUSTRIAL APPLICABILITY

The present disclosure readily allows determination of an appropriate exposure time period in Raman spectroscopy and therefore allows quick, accurate Raman spectroscopy of a sample. The Raman spectroscopy method and the Raman spectroscopy support device according to the present disclosure are therefore applicable not only to analytical applications but also to industrial applications, and can be used to perform Raman spectroscopy of samples readily and quickly in a variety of fields, for example, cosmetics, medicine, and food.

1. A Raman spectroscopy method comprising:
acquiring a first spectrum of a sample by performing exposure over a first time period in Raman spectroscopy of the sample;
calculating a first Raman signal intensity of the first spectrum acquired;
calculating a second time period from the first time period based on a ratio of the first Raman signal intensity calculated to a second Raman signal intensity that is a Raman signal intensity required for the Raman spectroscopy, the second time period being an exposure time period required for acquiring the second Raman signal intensity; and
acquiring a second spectrum of the sample by performing exposure over the second time period calculated.

2. The Raman spectroscopy method according to claim 1, wherein
the calculating of the first Raman signal intensity includes:
calculating a fluorescence intensity of fluorescence noise included in the first spectrum acquired;
calculating the first Raman signal intensity that is a Raman signal intensity corresponding to the fluorescence intensity in the first spectrum, based on a correlation between a fluorescence intensity of fluorescence noise and a Raman signal intensity in a spectrum of the Raman spectroscopy, the correlation being calculated in advance.

3. The Raman spectroscopy method according to claim 2, wherein
the calculating of the fluorescence intensity is performed by executing function fitting on a baseline that is fluorescence noise depending on a waveform of the first spectrum.

4. The Raman spectroscopy method according to claim 2, wherein
in the calculating of the fluorescence intensity, a maximum value of a baseline that is fluorescence noise depending on a waveform of the first spectrum is calculated as the fluorescence intensity.

5. The Raman spectroscopy method according to claim 2, wherein
the correlation is calculated in advance and corresponds to a type of the sample, and
the calculating of the first Raman signal intensity is performed based on the correlation corresponding to the type of the sample.

6. A Raman spectroscopy support device comprising:
an acquirer that acquires a first spectrum obtained by Raman spectroscopy in which a sample is exposed over a first time period;
a calculator that calculates
a first Raman signal intensity of the first spectrum acquired, and
a second time period from the first time period based on a ratio of the first Raman signal intensity calculated to a second Raman signal intensity that is a Raman signal intensity required for the Raman spectroscopy, the second time period being an exposure time period required for acquiring the second Raman signal intensity; and
an outputter that outputs an instruction to perform exposure over the second time period calculated.

7. The Raman spectroscopy support device according to claim 6, further comprising:
a storage that stores a correlation between a fluorescence intensity of fluorescence noise and a Raman signal intensity in a spectrum of the Raman spectroscopy, the correlation being calculated in advance, wherein
the calculator calculates:
a fluorescence intensity of fluorescence noise included in the first spectrum acquired by the acquirer; and
the first Raman signal intensity that is a Raman signal intensity corresponding to the fluorescence intensity in the first spectrum based on the correlation stored in the storage.
